(19) United States
(12) Patent Application Publication
(10) Pub. No.: US 2004/0084891 A1
(43) Pub. Date: May 6, 2004

(54) Advertising card

(76) Inventor: David J. Linn, Colorado Springs, CO (US)

Correspondence Address: SCOTT L. TERRELL, P.C., DENVER WEST OFFICE PARK, SUITE 225, 1746 COLE BLVD., GOLDEN, CO, 80401, US

(21) Appl. No.: 10/284,756

(22) Filed: Oct. 31, 2002

(51) Int. Cl. G09F 1/00

(52) U.S. Cl. 283/56

(57) ABSTRACT

An advertising card is provided which includes a supported blank having a frontal surface for display of an indicia, at least one depression extending across a width of the blank for folding the blank at an angle into a bottom section and a top section, with the bottom section attached to a side wall of any structure.

### CROSS REFERENCE TO RELATED APPLICATIONS

Not Applicable.

### BACKGROUND OF THE INVENTION

1. Field of the Invention

The present invention relates to advertising cards. In particular, it relates to removable and replaceable advertising cards.

2. Description of the Related Art

It is well known that hospitality guests often remove or mutilate advertising cards placed on the table or counter tops in hotel rooms and elsewhere. A solution is to provide a replaceable advertising card that can be easily attached to structures such as telephones, cash registers, and desk tops, for display in view of the customer while using the using the structure, or moving about the room.

Up to now a few examples of such cards exist. One example, U.S. Pat. No. 6,228,451, to Bondouris et al., discloses an adhesive backed card having advertising indicia printed on its surface for removable attachment to a structure. Another example, U.S. Pat. No. 5,458,282, to Martin, discloses a card having a magnetic sheet secured to one surface of the card for attachment to metallic articles. A third such example, U.S. Pat. No. 5,488,656, to DeArkland, discloses an outer faceplate for a large coin operated telephone having an external frame member affixed to the face plate. The frame member is attached proximate to one side of the dialing key pad area. The frame member defines through its periphery a framed panel area and the frame member has a raised rim portion for the positioning and support of an interchangeable advertising panel card.

While the foregoing examples offer some utility, a major disadvantage with each example lies in that each would require attachment to the surface of a structure such as a telephone faceplate which not only reduces the angle of view, but also severely limits the size of the advertisement without obscuring the necessary instructional information on the faceplate of a telephone, the key pad of a cash register, or cluttering the surface of a desk top. Thus, what is needed is an advertising card capable of removable attachment to the surface of any structure for the display of indicia to a hospitality guest, but which is also large enough to be observed while moving about a room. The present invention satisfies these needs.

### BRIEF SUMMARY OF THE INVENTION

It is therefore an object of the present invention to provide an advertising card which is capable of attachment to the surface of any structure for display of indicia to a hospitality guest while using the structure or moving about the room.

It is another object of the invention to provide a card which is capable of secure attachment to a telephone, but which is also large enough and at a viewing angle to be observed while moving about the room without obscuring necessary information on the face plate.

To overcome the problems of the prior art methods and in accordance with the purpose of the invention, as embodied and broadly described herein, briefly, an advertising card is provided which includes a supported blank having a frontal surface for display of an indicia, at least one depression extending across a width of the blank for folding the blank at an angle into a bottom section and a top section, and a means for attachment of the bottom section to a side wall of any structure.

Additional advantages of the present invention will be set forth in part in the description that follows and in part will be obvious from that description or can be learned from practice of the invention. The advantages of the invention can be realized and obtained by the apparatus particularly pointed out in the appended claims.

### BRIEF DESCRIPTION OF THE SEVERAL VIEWS OF THE DRAWINGS

The accompanying drawings, which are incorporated in and which constitute a part of the specification, illustrate at least one embodiment of the invention and, together with the description, explain the principles of the invention.

FIG. 1 is front view of a card according to a preferred embodiment of the invention.

FIG. 2 is a prospective view of the card according to FIG. 1.

FIG. 3 is a prospective view of a card according to another preferred embodiment of the invention.

FIG. 4 is a front view of a card according to a another preferred embodiment of the invention shown as an example when used as a telephone faceplate.

FIG. 5 is a side view of the card shown in FIG. 4.

FIG. 6 is a perspective view the card shown in FIG. 4 when used in connection with a standard desk top hospitality telephone.

FIG. 7 is a perspective view of a card illustrated in FIGS. 1 and 2 used in connection with a standard desk top hospitality telephone.

FIG. 8 is a perspective front view of yet another preferred embodiment of the invention showing the card used in connection with a clip attached to the back side wall of a telephone.

FIG. 9 is perspective rear view of the embodiment illustrated in FIG. 8 showing the manner in which the card in secured in the clip.

### DETAILED DESCRIPTION OF THE DRAWINGS

Unless specifically defined otherwise, all technical or scientific terms used herein have the same meaning as commonly understood by one of ordinary skill in the art to which this invention belongs.

Although any methods and materials similar or equivalent to those described herein can be used in the practice or testing of the present invention, the preferred methods and materials are now described. Reference now will be made in detail to the presently preferred embodiments of the invention, examples of which are illustrated in the accompanying drawings.

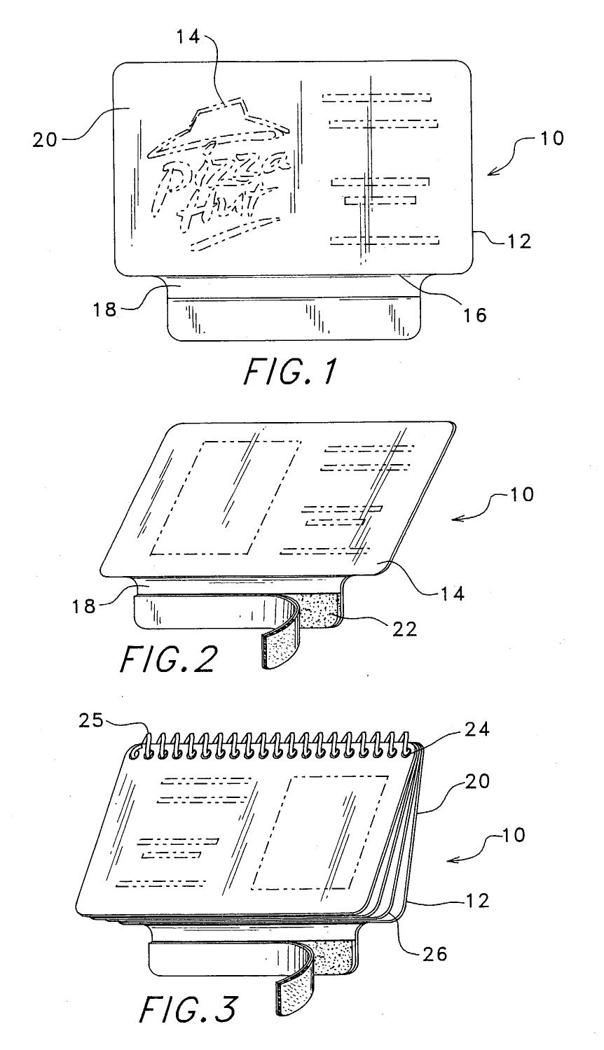

Referring now to the drawing figures, wherein like numerals represent like features, it is generally illustrated in FIGS. 1 and 2, a card 10 such as an advertising or notice card, according to a preferred embodiment of the invention. The card 10 is formed of a supported blank 12 having a frontal or display surface 14. The blank 12 may be made of paper, tag stock, or a synthetic material such as plastic. The blank 12 may include a coated layer of a type well known in the art for repelling liquids or debris.

The blank 12 is formed with one or more pressed depressions 16 extending across the width of the blank to divide the blank into a bottom section 18 and a top section 20. The bottom section is preferably 8.89 cm wide by 1.59 cm high, and the top section is preferably 7.62 wide cm by 12.7 cm high. The depression 16 is formed so as to facilitate a straight fold widthwise between the top section and the bottom sections. Thus, when used, the blank 12 may be folded in either direction depending on the desired viewing angle. The top surface 14 of the top section 20 can be printed with indicia for such as business advertising or information for display. The bottom section 18 is used for attachment to the side of a telephone box. As shown in FIG. 2, the top surface 14 of the bottom section 18 includes an adhesive backed hook and loop fastener 22 arrangement of a type well know in the art for removable attachment of the bottom section 18 to the side of any structure.

Referring now to FIG. 3, there is illustrated, a card, shown generally at 10, such as an advertising card formed of a blank portion. The blank portion 12 may be identical to the blank 12 of the first preferred embodiment of the invention. The blank portion 12 also has a top section 20. The upper edge of the top section 20 includes a plurality of equally spaced circular perforations 24 extending across the width of the upper edge of the blank 12 for receiving a spiral binder 25. The spiral binder is used to connect a plurality of single cards 26 in any manner well known in the art, for manual rotation about the upper edge of the top section 20. In this manner, the card 10 of the present invention supports several cards 26 of advertising, notification or other information, such as a menu, when the individual pages are rotated about the upper edge.

### EXAMPLE

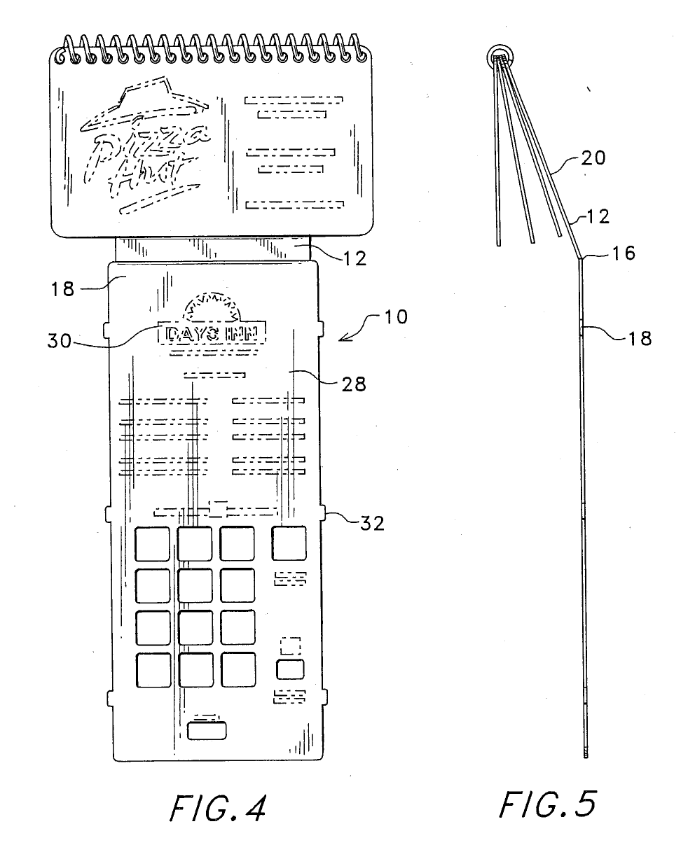

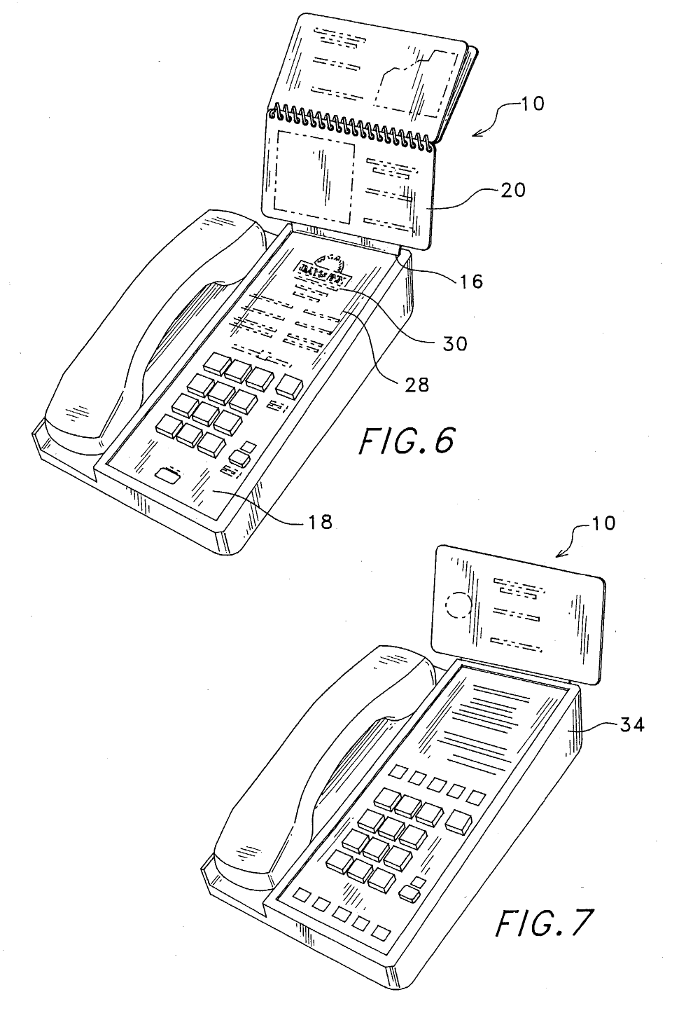

Referring now to FIG. 4, there is illustrated, a card, shown generally at 10 also formed of a blank portion 12 having a bottom section 18 and top section 20. However, in this illustration, there is shown an embodiment where the bottom section 18 of the blank 12 is configured as a removable telephone faceplate 28 for attachment to the telephone box. The face plate 28 has an upper display surface 30 imprinted with indicia such a dialing instructions or advertising information. The face plate 28 may, but need not, include lateral tabs 32 for securely attaching the face plate to the telephone by inserting tabs 32 into slots (not shown) in any conventional manner. FIG. 5, a sideview, illustrates the angled relationship of the blank 12 between the top 20 and bottom 18 sections at fold 16. This angled relationship between the top and bottom sections provides for ease in viewing, while moving about the room, of the indicia printed on the top surface 14 of the top section 20 of the card 10 when attached to the telephone, as shown in FIG. 6.

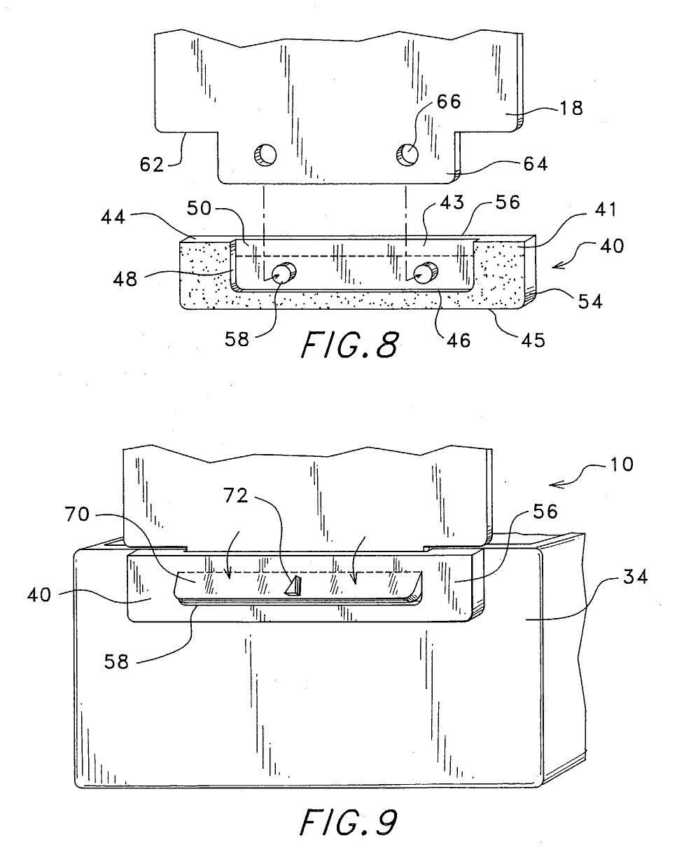

FIGS. 7, 8 and 9 illustrate yet another embodiment of the card 10 according to the present invention. FIG. 7 illustrates the completed attachment of the card 10 to the back edge of telephone box 34 using a clip 40 as illustrated in FIGS. 8 and 9. As shown in FIG. 8, clip 40 is a generally rectangular body having front 41, back 56, top 44, bottom 45 and side walls 54. Clip 40 further includes a rectangular groove 50 defined by lower 46, back 43, and side edges 48. The clip 40 is preferably molded of plastic, or milled, such that the groove 50 is formed for receiving the bottom section 18 of card 10. The rectangular groove 50 is formed such that it extends through the top wall 44 of clip 40 but is stops short of the bottom wall 45, side walls 54, and back wall 56 of the clip 40. In this manner, the groove 50 is also formed to include pins 58, having a length equal to the depth of the groove, integral to the back edge 43 of the groove 50, and which extend from the back edge 43 into the cavity of the groove 50. At the lower edge 62 of the bottom section 18 of card 10, a tab 64 is cut to match the interior dimensions of the grove 50 with holes 66 drilled in the tab 64 aligned to match the location and circumference of the pins 58. The surface of the front wall 41 of clip 40 is layered with adhesive (stippling) for attaching the front wall 41 to a rear side wall 34 of a telephone box.

FIG. 9 illustrates the a perspective view from the back wall 56 of the clip 40 when attached to the back side wall 34 of a table top telephone. Here, it is shown the manner in which the clip 40 operates to receive, secure, and release the bottom section 18 of card 10. A generally U-shaped cut 58 is pressed through the back wall 56 of the clip coexistent with the side 48 and lower edges 46 of the groove, but extending short of the clip 40 top wall 44 to define an elastically hinged flap 70 in the back wall 56. At the outer surface of the back wall 56 is a generally V-shaped handle 72 for outwardly engaging the pins 58 from the channel 50. To securely attach the bottom section 18 of card 10 to the rear side wall 34 of the telephone box, one places a finger of one hand against the handle 72 and then by pulling upward and outward folds the flap 72 outwardly from the back wall 56 thereby disengaging the pins 58 from the cavity of the groove. With the other hand, the operator then inserts the tab 64 in alignment with the interior of the groove 50 and pins 58, and with the one hand then pushes down on the handle 72 causing the flap 72 to fold downward and inwardly causing the pins 58 to fully engage the holes 66. The card 10 is released from the clip 40 simply by pulling upward and outward on the handle 72 causing the flap 72 to fold outwardly, disengaging the pins 58 from the holes 66, and then lifting the tab 64 out of the channel 50.

The pins 58 may also be formed so as to have an outwardly tapering upper surface (not shown), in direction from the channel of the groove to the back wall 56, so that the bottom section 18 is easily snap fit into the groove. With this configuration, to securely attach the bottom section 18 of card 10 to the rear side wall 34 of the telephone box, one simply pushes the bottom section 18 into the groove, biasingd the bottom edge of the bottom section against the tapered surface of the pins 58, which causes the flap 72 to fold outwardly until the pins 58 have aligned with the holes 66. Once aligned, the flap's hinged elasticity causes it to fold inwardly thus engaging the pins 58 with the holes 66.

While the present invention has been described in connection with the illustrated embodiments, it will be appreciated and understood that modifications may be made without departing, from the true spirit and scope of the invention.

I claim:

1. an advertising card, comprising:
(a) a supported blank having a frontal surface for display of an indicia;
(b) at least one depression extending across a width of the blank for folding the blank at an angle into a bottom section and a top section; and
(c) a means for attachment of the bottom section to a side wall of any structure.

2. The advertising card according to claim 1 wherein the attachment means is a hook and loop fastener adhered between the bottom section and the side wall.

3. The advertising card according to claim 1 wherein the bottom section is a telephone faceplate and the attachment means is fastening the faceplate to the telephone box.

4. The advertising card according to claim 1 wherein the attachment means includes a lower tab in the bottom section having at least one hole, the lower tab received in a groove of a clip fastener, the groove including a back wall having a hinged flap, and the hinged flap having at least one pin extending into a cavity of the groove for engaging the hole.

5. The advertising card according to claim 1, further comprising a plurality cards spiral bound to the top section.

6. The advertising card according to claim 1 wherein the structure is a telephone box, cash register, door handle, desk, dresser, or gas pump.

7. The advertising card according to claim 4 wherein the flap is elastically hinged and the pins include an outwardly tapering upper surface in a direction from the cavity of the groove to the back wall.
